(19) United States
(12) Patent Application Publication
(10) Pub. No.: US 2026/0288212 A1
(43) Pub. Date: Sep. 24, 2026

(54) MODULAR EDGE COMPUTING AND STORAGE SYSTEM

(71) Applicant: Seagate Technology LLC, Fremont, CA (US)

(72) Inventors: Niranjan Anant Pol, Pune (IN); Nahoosh Hemchandra Mandlik, Mumbai (IN); Hemant Vitthalrao Mane, Pune (IN)

(21) Appl. No.: 19/331,230

(22) Filed: Sep. 17, 2025

(30) Foreign Application Priority Data
Mar. 21, 2025 (IN) 202511025984

(51) Int. Cl. G06F 1/18

(52) U.S. Cl. CPC G06F 1/181

(57) ABSTRACT

A computing apparatus has a modular enclosure with a first major surface with a first sliding mount interface and a second major surface opposed to the first major surface with second sliding mount interface. The second sliding mount interface is slidably connectable with a corresponding first sliding mount interface of a second computing apparatus having the modular design. The enclosure further includes a first minor surface with a third sliding mount interface and a second minor surface opposed to the first minor surface with a fourth sliding mount interface. The fourth sliding mount interface is slidably connectable with a corresponding third sliding mount interface of the second computing apparatus.

### SUMMARY

The present disclosure is directed to a system for edge computing and storage. In one embodiment, a computing apparatus has a modular enclosure. The enclosure includes a first major surface with a first sliding mount interface and a second major surface opposed to the first major surface with second sliding mount interface. The second sliding mount interface is slidably connectable with a corresponding first sliding mount interface of a second computing apparatus having the modular design. The enclosure further includes a first minor surface with a third sliding mount interface and a second minor surface opposed to the first minor surface with a fourth sliding mount interface. The fourth sliding mount interface is slidably connectable with a corresponding third sliding mount interface of the second computing apparatus. The enclosure also includes a connector surface extending to respective first edges of: the first and second major surfaces; and the first and second minor surfaces. The enclosure includes an end surface opposed to the connector surface. The end surface is joined with the respective second edges of: the first and second major surfaces; and the first and second minor surfaces.

These and other features and aspects of various embodiments may be understood in view of the following detailed discussion and accompanying drawings.

### BRIEF DESCRIPTION OF THE DRAWINGS

The discussion below makes reference to the following figures, wherein the same reference number may be used to identify the similar/same component in multiple figures.

FIG. 1 is a schematic diagram of an edge analytics system according to an example embodiment;

FIG. 2 is block diagram illustrating an edge analytics use case according to an example embodiment;

FIGS. 3A and 3B are block diagrams of edge analytics and data mover devices according to example embodiments;

FIG. 4 is an end view of interconnected device enclosures according to an example embodiment;

FIG. 5 is an isometric view of an edge analytics device according to an example embodiment;

FIG. 6 is an isometric view of an end surface of an enclosure according to an example embodiment;

FIGS. 7 and 8 are isometric views showing internal components of an edge analytics device according to example embodiments;

FIG. 9 is an isometric view showing internal components of a data mover device according to an example embodiment;

FIGS. 10 and 11 are end views showing enclosure connection schemes according example embodiments;

FIG. 12 is a front view of a rack mounted system according to an example embodiment; and

FIG. 13 is a flowchart of a method according to an example embodiment;

### DETAILED DESCRIPTION

The present disclosure is generally related to an edge computing device for purposes such as data analysis of large installations such as factories, data centers, hospitals, transportation, warehouses, etc. For example, a factory may have a large number of interacting machines, products, and processes that are continually monitored for purposes such as quality assurance and productivity. As the systems become more complex, it becomes more difficult to catch problems such as manufactured products drifting from design specifications and/or bottlenecks that end up slowing down a manufacturing line.

Embodiments described below are directed to computing systems that are designed to analyze data generated by complex systems, determine anomalies as they develop, and provide models that can predict the effects of various system inputs on the anomalous data in order to correct or compensate for the anomalies. These systems typically utilize machine learning models (e.g., artificial neural networks) to automatically build models that can predict system behaviors based on real time gathering of inputs and outputs to a system. For example, a circuit board assembly line may have a number of stations where, among other things, circuit boards are prepared (e.g., inspected, cleaned), components are added to the boards (e.g., pick and place), components are bonded (e.g., wave soldering machine), attached components are inspected, and then finished circuit boards are tested. This process can generate a large amount of data in real-time that is amenable to analysis via machine learning models.

Embodiments below are described as edge compute systems, which generally refer to analytic systems that are moved “close” to the data being analyzed in order enable rapid data analysis as it is generated and provide solutions that can be applied equally or nearly as quickly. This is opposed to a physically separate facility such as a data center coupled via a wide-area network (WAN) to the data sources. While large data centers still add value in this scenario (e.g., improve existing models and develop new models), the trend for complex systems management is to provide the computing and storage resources physically close to the data sources to enable near-real-time analytics and response.

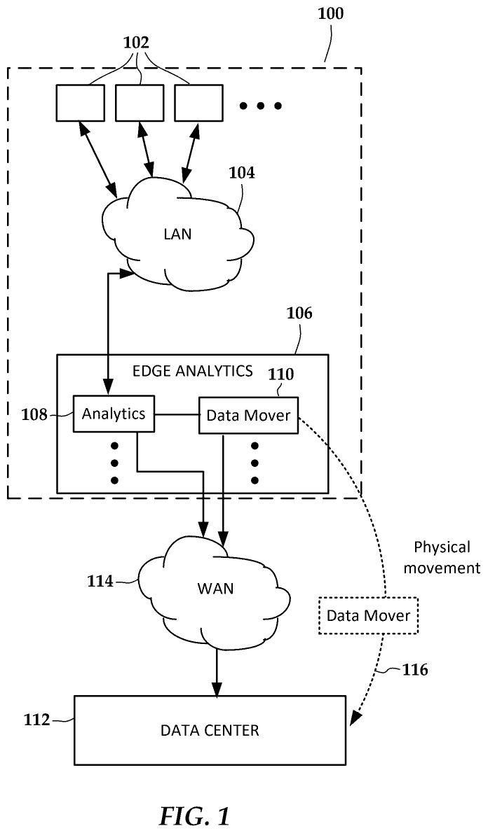

In FIG. 1, a block diagram shows how an edge computing system may be deployed according to an example embodiment. A facility 100 is generally a collection of operational units 102 that are capable of generating data and optionally receiving inputs to alter their behavior that affects the system as a whole. For example, an operational unit 102 such as a robotic welder may generate data related each weld it makes (e.g., temperature, welding time, amperage, camera image of the weld) as well as accept changes to its operating inputs for subsequent welds, e.g., changing a setting affecting welding current. Other cases, an operational unit 102 such as a standalone sensor may just generate data but changes to its settings may not generally have any direct effect on the process. A sensor may still have indirect effects, e.g., if it is generating erroneous data that is being used to affect other machines that are directly involved in the process.

The operational units generally communicate data via a local area network (LAN) 104. There are other ways of transmitting data, e.g., via point-to-point data connections, and the illustration of a LAN 104 is not meant to be limiting. An edge analytics system 106 is located in or near the installation 100 and gathers data via the LAN 104 and/or other means. The edge analytics system 106 includes one or more analytics processors 108 that perform inference calculations using a machine learning models, as well as other data processing operations such as storing raw data, performing data reduction/smoothing/encoding, etc. Multiple analytics processors 108 may be work together to distribute the analytics processing into subtasks, either by a discrete partition of duties and/or using a clustering scheme.

The edge analytics system 106 may also include a data mover 110 that has high capacity, rugged storage, e.g., solid-state drives (SSD). Depending on the scenario, the data mover 110 can act as a data cache that copies data from the analytics processor 108 and sends it out, e.g., to a data center 112 via a WAN 114. The data center 112 may have more diverse capability to analyze the data than the analytics processor 108, and may use the data for other purposes, e.g., to build and train new machine learning models.

As indicated by dotted line 116, the data mover 110 can be physically removed from the edge analytics system 106 and transported to the data center 112 or other such facility. For very large amounts of data, e.g., in the multiple terabyte (TB) range, it can be faster and more reliable to ship a data storage unit to a remote location than to upload it over the WAN 114, although both may be done at the same time, e.g., one data mover 110 is shipped for a fast response at a first destination and another data mover 110 (or the edge analytics processor 108) remains on site to upload the data to cold storage via the WAN 114 at a second destination.

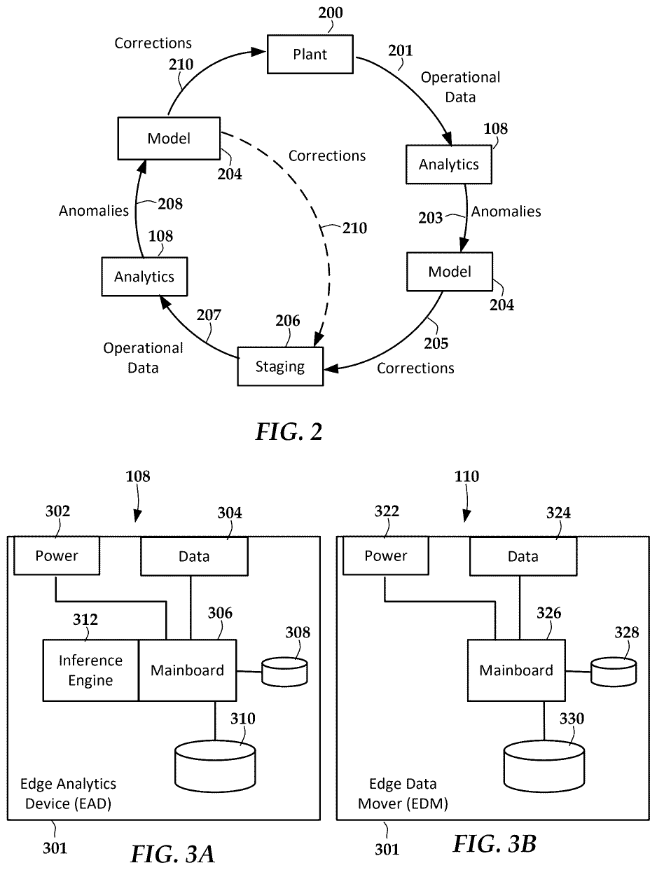

In FIG. 2, a block diagram shows a process in which the analytics system can be used according to an example embodiment. A plant 200 includes a system with inputs and outputs that includes a collection of sensors and other data producers that describe the operation of the system. For example, a factory may be considered a system with raw materials as inputs, finished products as outputs, with machines and humans that generate data descriptive of the process of transforming the inputs to the outputs. The factory's performance can be judged based, for example, on productivity (number of units produced over a measure of time) and quality (e.g., how closely the output conforms to specification) In another example, an autonomous vehicle may receive inputs in the form of camera, radar, lidar, maps, etc. as well as a navigation target. The output is a time series of commands that move the vehicle through the sensed environment. The vehicle's performance can be also judged, for example, on productivity (e.g., how efficiently the vehicle navigates to the target) and quality (e.g., avoidance of collisions, adherence to traffic rules).

The plant 200 provides operational data 201 from sensors that is received by the analytics processor 108. The analytics processor 108 inputs the operational data to an internal inference engine (not shown) that is trained on behavior of the same plant 200 or an equivalent plant. The inference engine will identify anomalies 203 that may, for example, indicate an undesirable trend in an output of the plant 200. A model 204 of the plant (which may include the inference engine) is used to model the effects on the anomalies 203 in response to adjusting plant inputs. If a change in inputs to the model is found to address the anomaly, these can be provided as corrections 205 to the plant inputs.

The corrections 205 may be applied directly to the plant 200, however this figure shows an optional validation that is performed via a staging system 206. Generally, the staging system 206 may be physical copy of some or all of the plant and/or may include part of the plant itself. For example, if the plant has multiple manufacturing lines that produce the same product, one of those lines can be used for staging with the corrections 205 applied while the others continue unchanged. The staging system 206 will provide its own operational data 207 that is again processed via the analytics processor 108 (or an equivalent) and again monitored for anomalies 208, which may be the same or different than anomalies 203.

The anomalies 208 may be a reduced set or empty set compared to the original anomalies 203, in which case the corrections can be again be optionally run through the model 204 (or an equivalent) to provide corrections 210 to the plant 200. In some cases, the anomalies 208 may not be improved over original anomalies 203, or the corrections 205 may cause unintended side effects that are reflected in the anomalies 208. In such a case, the corrections 210 may also include changes to remedy the anomalies 208 that may still require validation. Thus as indicated by dashed line, the corrections may be again fed back into the staging system 206 in an iterative process until the system achieves a desired state.

In FIG. 3A, a block diagram shows hardware components of an analytics processor 108 according to an example embodiment. The analytics processor 108, also referred to herein as an Edge Analytics Device (EAD), includes a physical enclosure 301 that will be described in detail further hereinbelow. A power interface 302 and data interface 304 are accessible from the outside of the enclosure, and include the physical connectors as well as specific hardware and protocols compatible with other devices, e.g., power supplies, networking devices, etc. The data interface 304 enables high-speed data transfer in and out of the EAD 108, e.g., using high speed Ethernet interfaces. The data can be transferred to the data center/cloud if good network connectivity is available and/or can be transferred to an data mover 110 which in turn can be hand carried to upload the data to the data center.

The EAD 108 includes a mainboard 306 with computing hardware such as central processing unit (CPU), random access memory (RAM), and input/output (I/O) interfaces. The mainboard 306 may include or be coupled to a first persistent storage 308 that provides instructions (e.g., operating system, programs) that governs operation of the device. A second persistent storage 310 is provided for storing raw data received from the plant/installation, as well as storing other versions of the data, e.g., reduced format for analysis, encoded format for feeding into a neural network, inference outputs, etc. The second persistent storage has large capacity (e.g., an array of 14TB-plus drives) which may be provided economically by using hard disk drives (HDD).

The EAD 108 includes an inference engine 312 with special-purpose hardware (e.g., processors and coprocessors) that is optimized to perform machine learning calculations efficiently. These calculations include vector operations associated with neural networks and may be used with other forms of machine learning, e.g., state vector machines, hidden Markov models. In one embodiment, the inference engine 312 is incorporated into an M.2 form factor that connects to an M.2 connector on the mainboard 306.

In FIG. 3B, a block diagram shows hardware components of a data mover 110 according to an example embodiment. The data mover 110, also referred to herein as an Edge Data Mover (EDM), includes the same physical enclosure 301 that will be described in detail further hereinbelow. A power interface 322 and data interface 324 are accessible from the outside of the enclosure, and include the physical connectors as well as specific hardware and protocols compatible with other devices, e.g., power supplies, networking devices, etc. The data interface 324 enables high-speed data transfer in and out of the EDM 110, e.g., using high speed Ethernet interfaces. The data can be transferred from the EAD 108 into the EDM 110 as it is being collected by the EDM 110. At some point, the data collected and stored in the EDM 110 can be hand carried to be uploaded to a data center.

The EDM 110 includes a mainboard 326 with computing hardware such as central processing unit (CPU), random access memory (RAM), and input/output (I/O) interfaces. The mainboard 326 may include or be coupled to a first persistent storage 328 that provides instructions (e.g., operating system, programs) that governs operation of the device. A second persistent storage 330 is provided for storing raw data received from the EAD 108. The second persistent storage has large capacity which may be provided by using solid-state drives (SSD). While SSD may be more expensive per unit of storage than HDD, due to potential for the EAD 108 to be regularly shipped to remote locations for data download, the physical ruggedness of SSD justifies the cost to ensure the EAD is portable over different modes of transportation, e.g., courier, commercial shipment, etc.

Note that both the EAD 108 and EDM 110 are shown utilizing a common, modular enclosure 301. The design enclosure 301 design enables to use of the similar enclosure for both the devices and also allows a flexible combination of devices to be deployed in a cabinet, e.g., a 12U chassis. Such combination (e.g., number of EAD and EDM units) can be varied depending upon analytic and data movement workloads. Among other this, the enclosure 301 is built to withstand harsh environment (extreme temperatures, moisture, dust and impact). The enclosure 301 can be made with aluminum (robust material) which provides shock absorption, resistance to corrosion, and good heat transfer characteristics. The enclosure walls and interfaces (e.g., power and data connectors) can be adapted and configured use gaskets and seals to prevent ingress of water, dust, and debris. The use of aluminum material with proper heat sink design (number of fins, proper dimensions of fins) manages heat dissipation and use of thermal pads (TIM)/conductive materials to optimally transfer the heat from the source, e.g., heat generating electronics inside the case. This enables uses in a number of different environments and applications, such as industrial, transportation, outdoor installations, etc.

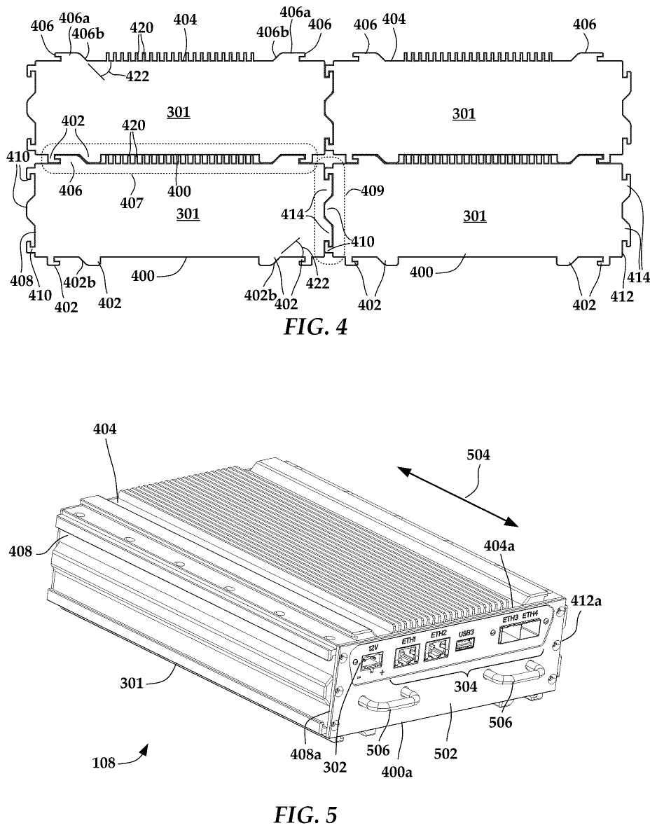

In FIG. 4, a front view of multiple enclosures 301 shows mechanical interconnectivity between enclosures according to an example embodiment. Each enclosure includes a first major surface 400 with a first sliding mount interface 402. A second major surface 404 is opposed to the first major surface 400. The second major surface 404 has second sliding mount interface 406. The second sliding mount interface 406 is slidably connectable with a corresponding first sliding mount interface 402 of a second computing apparatus having the modular design (see highlighted region 407).

The enclosure includes a first minor surface 408 with a third sliding mount interface 410. A second minor surface 412 is opposed to the first minor surface 408 with a fourth sliding mount interface 414. The fourth sliding mount interface 414 is slidably connectable with a corresponding third sliding mount interface 410 of a second computing apparatus having the modular design (see highlighted region 409).

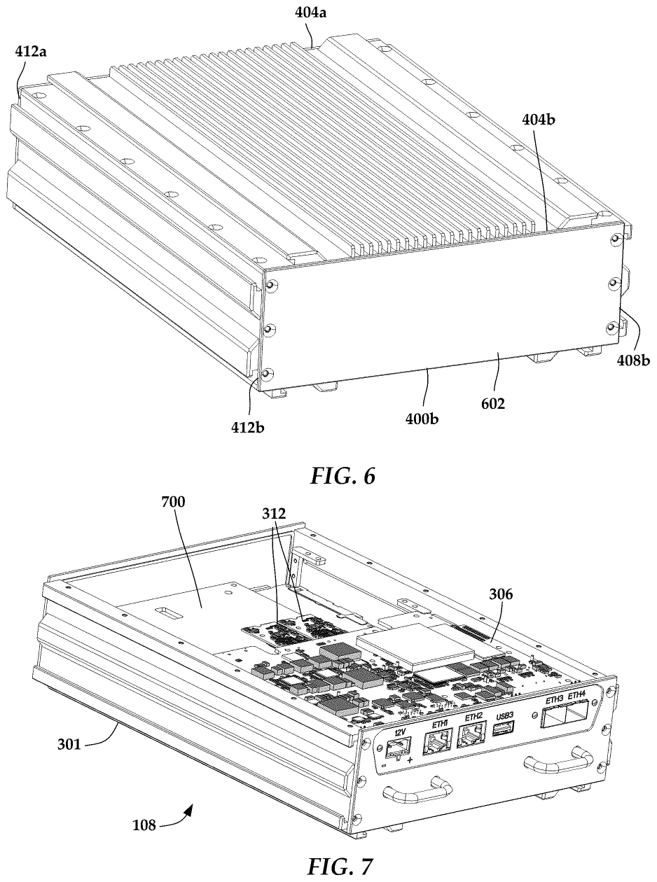

For purposes of this disclosure, a major surface is a surface of the enclosure having a maximum surface area. For example, a cuboid will have at least two major surfaces. Also for purposes of this disclosure, a minor surface is any surface having a surface area less than that of the major surface, and does not need to be a minimum surface area. So if an enclosure has two major surfaces, it will have four minor surfaces. In particular, the minor surfaces 408, 412 in this example have a greater surface area than the connector surfaces and end surfaces shown in FIGS. 5 and 6, but are still considered minor surfaces for purposes of this disclosure, as the pertinent major/minor relationship is between surfaces with sliding interfaces. For cubic shapes where all surfaces have the same surface area, the terms major and minor can be replaced with first and second, unless otherwise indicated.

Also seen in FIG. 4 are heat sink ribs 420 extending away from the second major surface 404. The heat sink ribs 420 may be configured to contact a corresponding first major surface 400 of the second computing apparatus when the second sliding mount interface 410 is connected with the corresponding first sliding mount interface 402 as shown in highlighted region 407. This contact can help increase enclosure-to-enclosure heat transfer. In other embodiments, the heat sink ribs 420 may be configured to be separated by a gap (not shown) from the corresponding first major surface 400 of the second computing apparatus when the enclosures are coupled. Such a gap can provides a greater cross sectional area therebetween through which cooling air can flow. In either configuration, the first through fourth sliding interfaces 402, 406, 410, 414 provide device-to-device conductive heat transfer paths that can help distribute heat, e.g., move heat from warmer devices to cooler devices thereby reducing maximum temperatures.

As seen in this example, the second sliding mount interface 406 comprises a pair of symmetrical rails 406a. The heat sink ribs 420 are disposed between the symmetrical rails 406a. The symmetrical rails have sides 406b facing the heat sink ribs 420 that are at an angle 422 of between 40 and 50 degrees from the second major surface, preferable about 45 degrees. The first sliding mount interface 402 has interfacing sides 402b at the angle 422 relative to the first major surface 400. Generally, placing the symmetrical rails 406a near the edges of the second major surface 404 increases the structural rigidity of the assembly when coupled to first sliding mount interface 402 of another device.

In FIG. 5, a perspective front view shows an EAD 108 with the common enclosure 301. As seen in this view, the enclosure 301 includes a connector surface 502 extending to first edges 400a, 404a of the first and second major surfaces 400, 404; and first edges 408a, 412a of the first and second minor surfaces 408, 412. The connector surface 502 in this example is configured with the power interface 302 and data interface 304 of the EAD 108, but this surface 502 can be alternately configured without affecting the modular, interlocking, building-block-like sliding interfaces of the enclosure 301. One advantage of this design is that other types of devices with different connector interfaces can be functionally integrated with a collection of EAD 108 and EDM 110 devices so long as their electronics fit in the common enclosure 301.

In FIG. 6, a perspective end view of the common enclosure 301 is shown.

The enclosure 301 includes an end surface 602 opposed to the connector surface 502 the end surface 602 is joined with the respective second edges 400b, 404b of the first and second major surfaces 400, 404 and respective second edges 408b, 412b of the first and second minor surfaces 408, 412. The end surface 602 is closed and featureless in this example, e.g., includes no connectors, display elements, handles, etc.

In reference again to FIG. 5, the first through fourth sliding mount interfaces 402, 406, 410, 414 are configured to slide in a direction 504 defined between the connector surface 502 and the end surface 602. As mentioned, the enclosures 301 may be mounted in a cabinet, rack, or the like, or the enclosures 301 may be standalone or connected to each other without a cabinet. When used outside of a cabinet or rack, the enclosures 301 may be deployed so that the connector surface 502 is facing upwards, away from ground, so that convective air flow can remove heat from the ribs 420. The sliding interfaces 402, 406, 410, 414 can also act as heat transfer ribs/fins in this orientation, particularly when not coupled to an adjacent enclosure 301.

If the enclosures 301 are mounted in a cabinet or rack with forced air cooling, the enclosures 301 may be mounted in any orientation, and the direction of airflow can be configured along direction 504. As will be described below, a sliding rack or cabinet interface may draw heat conductively from sliding interfaces 402, 406, 410, 414, allowing a conductive or radiative heat transfer mechanism (e.g., cold plate) to further enhance cooling of the enclosures 301 in addition to or instead of forced airflow.

The aforementioned angles 422 on the first and second interfaces 402, 406 as well as corresponding angles on the third and fourth sliding interfaces 410, 414 facilitate smooth motion when coupling and uncoupling the units. Other sliding interface shapes and dimensions are contemplated, e.g., more convoluted shapes that increase heat transfer area for convective, conductive, and radiative heat transfer. The EAD and EDM devices 108, 110 include internal heat transfer paths (e.g., conductive pads, heat transfer towers) that thermally couple active electronics within the enclosures 301 with the surfaces of the enclosures 301.

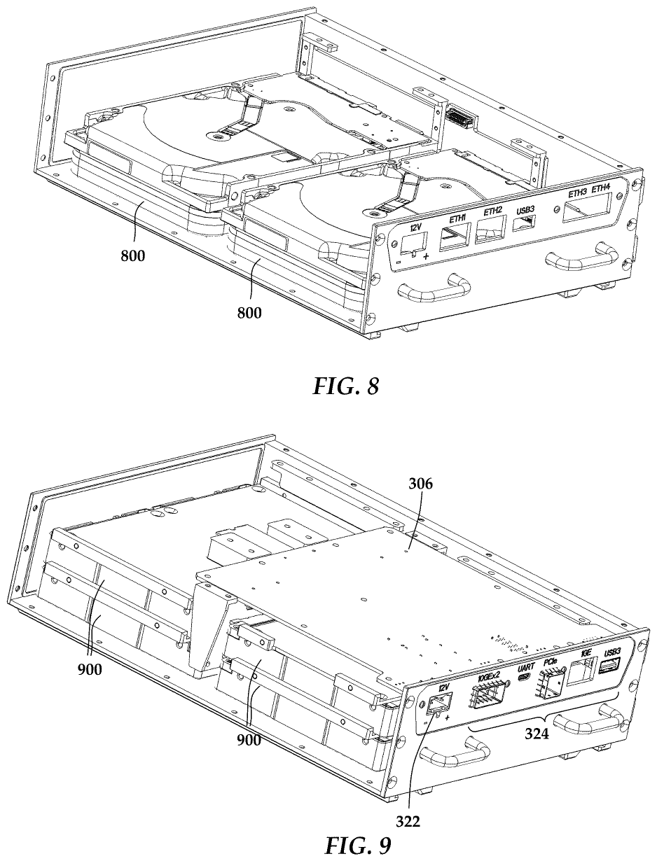

As previously noted, FIG. 5 shows an EAD 108 device. The data interface 304 includes two pairs of Ethernet connectors, which allow for simultaneous gathering of data from an installation and offloading of data to an EDM device 110 and/or a WAN. Also seen on the connector surface 502 are handles 506, which may be used on both EAD and EDM. In FIG. 7, an isometric view shows details of the EAD 108 with a panel corresponding to the second major surface 404 removed. The mainboard 306 can be seen in this view, as well as two inference engine cards 312 which have an M.2 form factor. An HDD plate 700 can be seen separating the circuit boards from a lower storage section. The HDD plate 700 provides structural rigidity and can serve as a heat transfer path to the outer surfaces of the enclosure 301. In FIG. 8, an isometric view shows details of the EAD 108 with the panels corresponding to the second major surface 404 and first minor surface 408 removed, as well as the mainboard 306. A pair of 3.5-inch form factor HDDs 800 can be seen mounted on or near the panel corresponding to the first major surface 400.

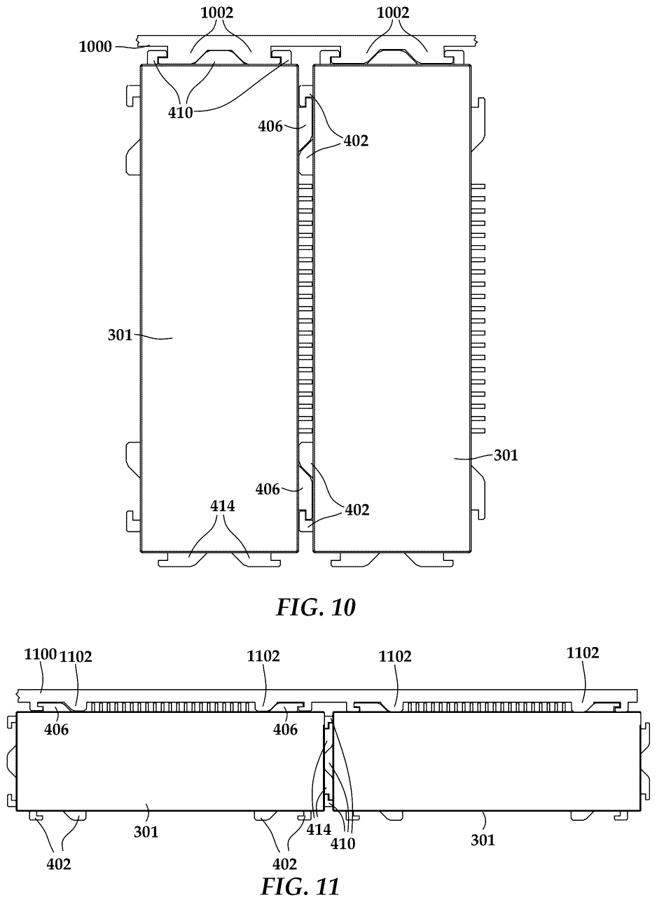

In FIG. 9, an isometric view shows an EDM 110 according to an example embodiment, with the panels corresponding to the second major surface 404 and first minor surface 408 removed. The connector surface 502 includes the power interface 322 and data interface 324. The data interface 324 includes 10 Gigabit (1G) Ethernet and PCIe ports. The data interface 324 also has a 1G Ethernet interface which can serve as a management port, e.g., to switch the interface between Ethernet and PCIe interfaces for data transfer at run time. In FIG. 10, an isometric view shows details of the EDM 110 with a panel corresponding to the second major surface 404 removed. The mainboard 326 can be seen in this view, as well as four 2.5-inch form factor SSDs 900. The EDM 110 device exposes the SSDs 900 as a high-capacity single volume and exposes NVMe-OF TCP storage device using Ethernet frontend and as NVMe device using PCIe frontend. It also provides as an elastic storage when connected with the EAD 108 using the Ethernet frontend.

The common enclosure 301 is engineered to support modular stacking, enabling seamless integration of multiple units of different devices in both vertical and horizontal orientations (e.g., with the connector panel parallel to the ground, with the first and second major surfaces parallel to the ground, or with the first and second minor surfaces parallel to the ground) as well as orientations that are tilted relative to the ground. The enclosure design facilitates adaptability for standalone deployment or rack-mounted configurations, optimizing space utilization and structural stability. The interlocking mechanism allows enclosures to be securely stacked using one, two, three, or four contact surfaces. This ensures mechanical alignment, load distribution, and structural integrity, making the design suitable for applications requiring scalable deployment in constrained environments.

As previously noted, the enclosure 301 may be mounted in a container such as a cabinet, rack, case, or the like. In FIG. 10, an end view shows two enclosures 301 that are fastened to a cabinet slide mount interface 1000 according to an example embodiment. The cabinet slide mount interface 1000 couples with the third sliding mount interface 410, although a slide mount that interfaces instead with the fourth sliding mount interface 414 may be considered an equivalent variation. The cabinet slide mount interface 1000 is shown as a single piece that connects two or more enclosures 301, although may be provided as separate pieces. The spacing between sliding features 1002 of the interface 1000 is such that the first and second sliding mount interfaces 402, 406 are aligned and can be slidably joined together when the third sliding mount interfaces 410 are joined to the cabinet slide interface 1000.

In FIG. 11, an end view shows two enclosures 301 that are fastened to a cabinet slide mount interface 1100 according to another example embodiment. The cabinet slide mount interface 1100 couples with the second sliding mount interface 406, although a slide mount that interfaces with the first sliding mount interface 402 may be considered an equivalent variation. The cabinet slide mount interface 1100 is shown as a single piece that connects two or more enclosures 301, although may be provided as separate pieces. The spacing between sliding features 1102 of the interface 1100 is such that the third and fourth sliding mount interfaces 410, 414 are aligned and can be slidably joined together when the second sliding mount interfaces 406 are joined to the cabinet slide interface 1100.

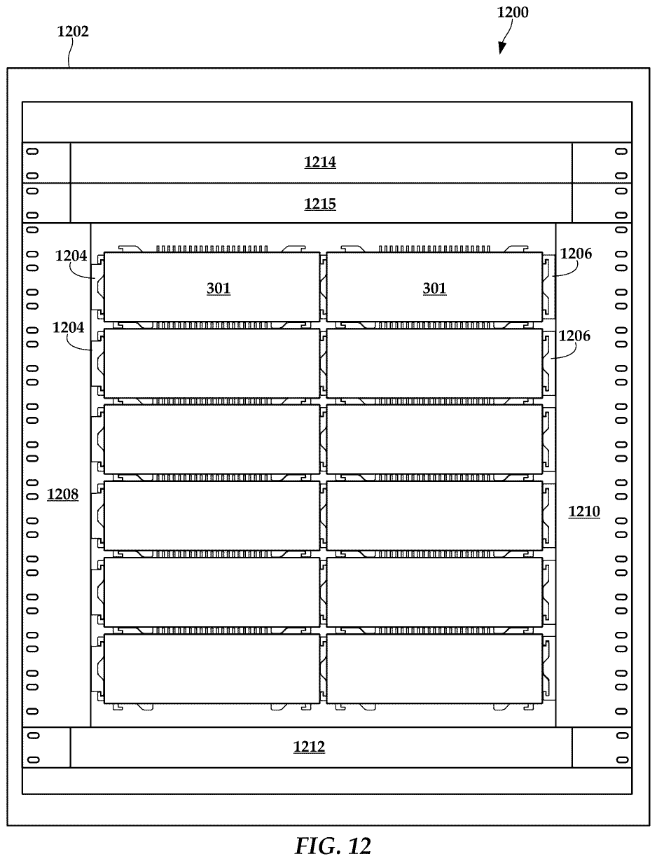

In one embodiment, the dimensions of the enclosure 301 are about 60 mm high, 232 mm deep, and 175 mm wide (about 2.4 in×6.9 in×9.1 in). The height and depth dimensions can be selected based on the requirements of the devices within the enclosure, as a wide variety of racks are available for different height and depth of device. The width dimension facilitates placing the enclosures two across in a standard 19 inch rack. Such an arrangement is shown in FIG. 12, which is an end view of a rack mounted system 1200 according to an example embodiment. In this example, 12 devices (e.g., EAD and EDM devices) are slidably mounted in a cabinet enclosure 1202 that houses an array of devices. The array includes six rows, each row having two devices coupled side-by-side via third and fourth sliding mount interfaces of the enclosures 301. The devices within the rows are coupled to other devices within other rows via one or both first and second sliding mount interfaces.

A set of slide mounts 1204, 1206 receive and secure the minor surface sides of the enclosures 301. Brackets 1208, 1210 connect the slide mounts 1204, 1206 to mounting rails of the enclosure 1202. Other rack mountable devices can be mounted in the enclosure 1202, such as a power supply 1212 and Ethernet switches 1214, 1215, all shown in 1U rack mount configurations. The connector surfaces of the enclosures 301 face forward allowing easy access to add interconnecting cables between the enclosures 301 and the other components 1212, 1214, 1215. The forward facing orientation of the connectors facilitates data-coupling the various devices to each other and/or to the switches 1214, 1215, as well as power-coupling the devices to the power supply 1212.

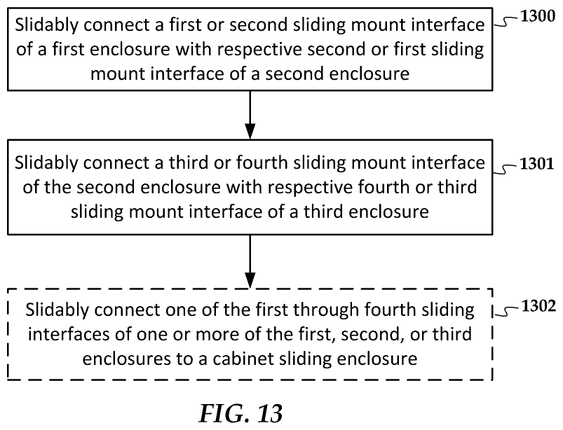

In FIG. 13, a flowchart illustrates a method according to an example embodiment. The method is directed to mechanically coupling first, second, and third computing apparatuses each comprising a modular enclosure of common interface design. Each enclosure includes a first major surface with a first sliding mount interface and a second major surface opposed to the first major surface with second sliding mount interface. Each enclosure also includes a first minor surface with a third sliding mount interface and a second minor surface opposed to the first minor surface with a fourth sliding mount interface. Each enclosure also includes a connector surface extending to respective first edges of: the first and second major surfaces; and the first and second minor surfaces; and an end surface opposed to the connector surface, the end surface joined with the respective second edges of: the first and second major surfaces; and the first and second minor surfaces.

The method involves slidably connecting 1300 the first or second sliding mount interface of the first enclosure with respective second or first sliding mount interface of the second enclosure. The method further involves slidably connecting 1301 the third or fourth sliding mount interface of the second enclosure with the respective fourth or third sliding mount interface of the third enclosure. The method may further involve slidably connecting 1302 one of the first through fourth sliding interfaces of one or more of the first, second, or third enclosures to a cabinet sliding enclosure.

The various embodiments described above may be implemented using circuitry, firmware, and/or software modules that interact to provide particular results. One of skill in the arts can readily implement such described functionality, either at a modular level or as a whole, using knowledge generally known in the art. For example, the flowcharts and control diagrams illustrated herein may be used to create computer-readable instructions/code for execution by a processor or multiple processors operating cooperatively. Such instructions may be stored on a non-transitory computer-readable medium and transferred to the processor for execution as is known in the art. The structures and procedures shown above are only a representative example of embodiments that can be used to provide the functions described hereinabove.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations (e.g., within 10%, 5%, etc.) that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

The foregoing description of the example embodiments has been presented for the purposes of illustration and description. It is not intended to be exhaustive or to limit the embodiments to the precise form disclosed. Many modifications and variations are possible in light of the above teaching. Any or all features of the disclosed embodiments can be applied individually or in any combination are not meant to be limiting, but purely illustrative. It is intended that the scope of the invention be limited not with this detailed description, but rather determined by the claims appended hereto.

1. A computing apparatus having a modular enclosure design, the enclosure comprising:
a first major surface with a first sliding mount interface;
a second major surface opposed to the first major surface with second sliding mount interface, the second sliding mount interface being slidably connectable with a corresponding first sliding mount interface of a second computing apparatus having the modular enclosure design;
a first minor surface with a third sliding mount interface;
a second minor surface opposed to the first minor surface with a fourth sliding mount interface, the fourth sliding mount interface being slidably connectable with a corresponding third sliding mount interface of the second computing apparatus;
a connector surface extending to respective first edges of: the first and second major surfaces; and the first and second minor surfaces; and
an end surface opposed to the connector surface, the end surface joined with the respective second edges of: the first and second major surfaces; and the first and second minor surfaces.

2. The computing apparatus of claim 1, wherein the second major surface includes heat sink ribs extending away from the second major surface, the heat sink ribs contacting a corresponding first major surface of the second computing apparatus when the second sliding mount interface is connected with the corresponding first sliding mount interface.

3. The computing apparatus of claim 2, wherein the second sliding mount interface comprises a pair of symmetrical rails, the heat sink ribs being disposed between the symmetrical rails.

4. The computing apparatus of claim 3, wherein the symmetrical rails have sides facing the heat sink ribs that are at an angle of between 40 and 50 degrees from the second major surface, the first sliding mount interface having interfacing sides at the angle.

5. The computing apparatus of claim 1, wherein the third and fourth sliding mount interfaces have respective third and fourth contacting sides that are at an angle of between 40 and 50 degrees.

6. The computing apparatus of claim 1, wherein the first through fourth sliding mount interfaces are configured to slide in a direction defined between the connector surface and the end surface.

7. A system comprising:
a first and second computing apparatuses each comprising a respective, modular first and second enclosures, the first and second enclosures each comprising:
a first major surface with a first sliding mount interface;
a second major surface opposed to the first major surface with second sliding mount interface;
a first minor surface with a third sliding mount interface;
a second minor surface opposed to the first minor surface with a fourth sliding mount interface;
a connector surface extending to respective first edges of: the first and second major surfaces; and the first and second minor surfaces; and
an end surface opposed to the connector surface, the end surface joined with the respective second edges of: the first and second major surfaces; and the first and second minor surfaces,
wherein the second sliding mount interface of the first or second enclosure is slidably connectable with the first sliding mount interface of the respective second or first enclosure, and the fourth sliding mount interface of the first or second enclosure is slidably connectable with a the third sliding mount interface of the of the respective second or first enclosure.

8. The system of claim 7, further comprising a cabinet enclosure that houses the first and second computing apparatuses, the cabinet including a cabinet slidable mount interface, connectable with at least one of the first through fourth sliding mount interfaces of the first and second enclosures.

9. The system of claim 8, where the first or second sliding mount interfaces of the first and second enclosures are coupled to the cabinet slidable mount interface, and wherein the third sliding mount interface of the first enclosure is coupled to the fourth sliding mount interface of the second enclosure.

10. The system of claim 9, where the third or fourth sliding mount interfaces of the first and second enclosures are coupled to the cabinet slidable mount interface, and wherein the first sliding mount interface of the first enclosure is coupled to the second sliding mount interface of the second enclosure.

11. The system of claim 7, wherein the first computing apparatus is an edge analytics device that collects and analyzes sensor data from a facility, and the second computing apparatus is an edge data mover device data-coupled to the edge analytics devices to copy the sensor data.

12. The system of claim 11, wherein the edge data mover device is portable to facilitate physical transport of the sensor data to a remote facility.
